(19) United States
(12) Patent Application Publication
(10) Pub. No.: US 2004/0159681 A1
(43) Pub. Date: Aug. 19, 2004

(54) Pump and a receptacle fitted therewith

(75) Inventors: Daniel Crosnier, Offranville (FR); Vanessa Brinkmeyer, Paris (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 10/733,256

(22) Filed: Dec. 12, 2003

Related U.S. Application Data
(60) Provisional application No. 60/438,324, filed on Jan. 7, 2003.

(30) Foreign Application Priority Data
Dec. 16, 2002 (FR) 0215911

(51) Int. Cl. G01F 11/06

(52) U.S. Cl. 222/321.7

(57) ABSTRACT

The present invention provides a pump (1; 60; 90) for mounting on a receptacle (3), the pump including:

an air intake passage formed between the pump body and the moving assembly and capable of communicating with the opening (18) of the pump body;

a first lip (40) arranged, after the moving assembly has moved away from a rest position in the substance-dispensing direction, to press in leaktight manner against the pump body and prevent communication between the inside of the receptacle and the pump chamber (6) via the opening (18); and

a second lip situated above the first lip when the pump is observed in the head-up position, said second lip being arranged to close the air intake passage when the moving assembly is in its rest position and to release said passage when the moving assembly (5) is displaced in the substance-dispensing direction.

The present invention relates in particular to a pump for mounting on a receptacle, and serving to dispense a substance in a head-up or a head-down position.

French patent application No. FR 2 528 122 discloses a pump enabling a substance to be dispensed in a head-up or a head-down position, and comprising a pump body with a moving assembly in the pump body and co-operating therewith to define a pump chamber of variable volume.

The pump body has a lateral opening enabling the substance contained in the receptacle to penetrate into the pump chamber when the pump is used head-down. The moving assembly has a lip enabling the above-mentioned opening in the pump chamber to be isolated after it has been moved a certain distance into the pump body.

Such a pump has two helical springs which are in contact with the substance, and that can lead to problems of compatibility between the substance and the metal of the springs.

In addition, that pump has a relatively large number of parts, which is reflected in its manufacturing cost.

Finally, if the pump is held head-down for a long period, it can happen that the substance will leak out, particularly if the substance is not very viscous.

There exists a need for a pump which remedies those drawbacks in full or in part, and in particular which is relatively simple in structure while enabling a substance to be dispensed in satisfactory manner, even when the substance is not very viscous.

In one of its aspects, the invention provides a pump for mounting on a receptacle, the pump comprising:

a pump body;

a moving assembly that is movable relative to the pump body and that co-operates therewith to define a pump chamber of variable volume, the pump chamber being suitable for communicating with the inside of the receptacle via at least one opening of the pump body disposed in such a manner as to enable the pump to operate in a head-down position,

the pump being characterizable by the fact that it further comprises:

an air intake passage formed between the pump body and the moving assembly and capable of communicating with the opening of the pump body;

a first lip arranged, after the moving assembly has moved away from a rest position in the substance-dispensing direction, to press in leaktight manner against the pump body and prevent communication between the inside of the receptacle and the pump chamber via the opening; and

a second lip situated above the first lip when the pump is observed in the head-up position, said second lip being arranged to close the air intake passage when the moving assembly is in its rest position and to release said passage when the moving assembly is displaced in the substance-dispensing direction.

The invention makes it possible in particular to reduce the risk of substance leaking. out in the event of the pump being held head-down at rest.

Since the moving assembly includes a dispenser orifice, the orifice can be situated, for example, on the side opposite from the opening if there is only one opening, thereby avoiding the pump chamber from emptying in the event of the pump being used in a substantially horizontal position with the dispenser orifice facing downwards.

Advantageously, each of the first and second lips presents a shape that is substantially frustoconical, flaring towards the pump chamber.

In an embodiment of the invention, the moving assembly includes a third lip disposed in such a manner as to be pressed against the pump body to close the air intake passage when the moving assembly is at the end of its substance-dispensing stroke, thus making it possible when the pump is used head-down to avoid substance leaking out even if the moving assembly is maintained for too long a time in its end-of-stroke position.

In a variant, the pump body and the second lip may be arranged in such as manner as to close the air intake passage when the moving assembly is at the end of its stroke, in which case the moving assembly need not have a third lip. In this variant, the pump body may include, for example, at least one setback, in particular a channel extending parallel to the axis along which the moving assembly moves, said setback being situated between two regions against which the second lip presses when the moving assembly repetitively occupies its rest position and its end-of-stroke position, the setback providing communication between said regions when the moving assembly occupies a position that is intermediate between its rest position and its end-of-stroke position.

In an embodiment of the invention, the moving assembly comprises a pushbutton and an insert fitted thereto, the pushbutton and the insert being arranged together to define a passage for delivering the substance, at least when the pump is actuated to dispense the substance.

The first, second, and third above-mentioned lips may be made on the insert.

In an embodiment of the invention, the pushbutton comprises two portions, one of which is stationary relative to the insert and the other is movable relative thereto, the insert and the movable portion of the pushbutton may include respective surfaces for co-operating to close the passage for delivering the substance when the moving assembly is in its rest position and for opening said passage when the movable portion is moved through a determined distance relative to the stationary portion.

Still in an embodiment, the pushbutton is arranged so that the movable portion can move through the above-mentioned determined distance relative to the insert from its rest position only when the force exerted on the pushbutton exceeds a threshold. This enables the passage for delivering the substance to be disengaged only once the substance has been compressed in the pump chamber.

The stationary portion and the movable portion of the pushbutton may be connected to each other by a web of elastically-deformable material, said web possibly presenting an annular shape.

In an embodiment of the invention, the pump includes a resilient return element suitable for returning the moving assembly into its rest position. The resilient return element may be placed outside the pump chamber and comprise, for example, a helical spring working in compression. Advantageously, the resilient return element is made integrally with the pushbutton.

In an embodiment of the invention, the pump body is arranged to enable a dip tube to be fastened thereto, and the pump may include a check valve that closes while the volume of the pump chamber is decreasing and that opens while the volume of the pump chamber is increasing, said check valve being disposed in such a manner as to enable the pump chamber to be fed with substance via the dip tube when the pump is used head-up.

Advantageously, the volume of the pump chamber in the rest position is greater than the volume of a quantity or “dose” of substance to be dispensed, thereby reducing the risk of the pump becoming unprimed.

In an embodiment of the invention, the pushbutton is entirely stationary relative to the insert, the insert possibly including a skirt suitable for co-operating in leaktight manner with a spike of the pump body while the pump is at rest in order to isolate the pump chamber from the outside.

The insert may include a check valve suitable for closing an upper opening of the skirt while the volume of the pump chamber is increasing and suitable for allowing substance to pass through while the volume of the pump chamber is decreasing.

The check valve may comprise a valve member that is connected to the skirt by a web of frangible material, prior to first use of the pump. The valve member may come into abutment against the spike when the pushbutton is depressed in order to rupture the web of frangible material.

Independently or in combination with the above, the invention also provides, in another of its aspects, a pump for mounting on a receptacle, the pump comprising:

a pump body, the pump body including a spike;

a moving assembly including a pushbutton and arranged to co-operate with the pump body to define a pump chamber of variable volume, the moving assembly including a skirt via which substance present in the chamber can be delivered towards a dispensing orifice, the skirt being capable of co-operating with the spike when the pump is at rest in order to isolate the inside of the skirt from the pump chamber.

By way of example, the skirt may be provided with a valve member which, prior to first use of the pump, is connected to the skirt by a web of frangible material. When the moving assembly is moved downwards on first use of the pump, the valve member comes into abutment against the spike and is moved inside the skirt until it reaches a position where the valve member co-operates with an upper opening of the skirt to form a check valve. In operation of the pump, the check valve opens while the volume of the pump chamber is decreasing and closes while the volume of the pump chamber is increasing, thereby preventing air from being sucked into the pump chamber and enabling it to become filled with substance.

The invention also provides a receptacle fitted with a pump as defined above.

In another of its aspects, the invention also provides independently or in combination with the above, a pump for mounting on a receptacle, the pump comprising:

a pump body;

a moving assembly that is movable relative to the pump body and that co-operates therewith to define a pump chamber of variable volume;

the pump being characterizable by the fact that the moving assembly comprises a pushbutton and an insert fitted thereto, the pushbutton and the insert being arranged together to define a passage for delivering the substance when the pump is actuated to dispense the substance, and by the fact that the pushbutton comprises two portions, one of which is stationary relative to the insert and the other of which is movable relative thereto, the movable portion and the insert having respective surfaces suitable for co-operating to close the passage for delivering the substance when the moving assembly is in is rest position and for disengaging said passage when the movable portion is moved through a determined distance relative to the stationary portion.

The invention can be better understood on reading the following detailed description of non-limiting embodiments thereof, and on examining the accompanying drawings, in which:

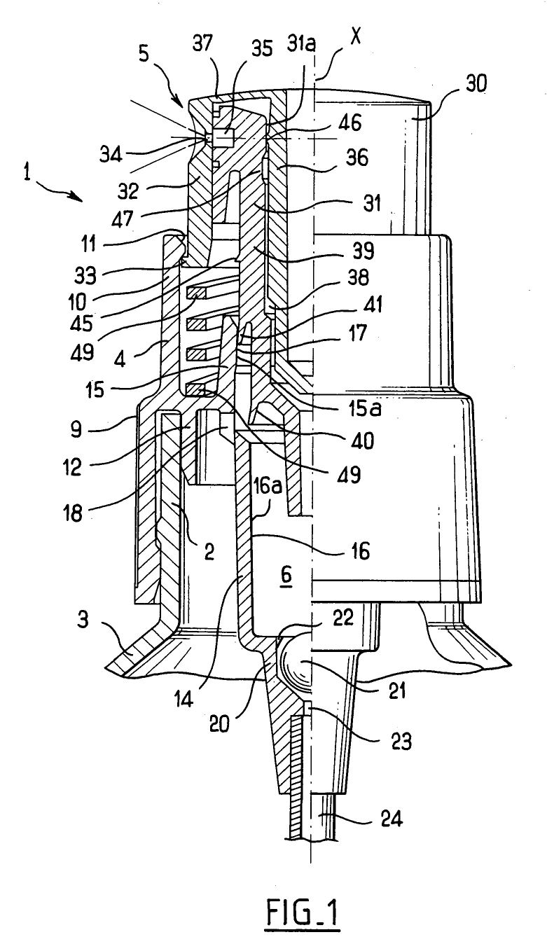

FIGS. 1 to 3 are diagrammatic and fragmentary views in axial half-section of a pump mounted on a receptacle and constituting an embodiment of the invention;

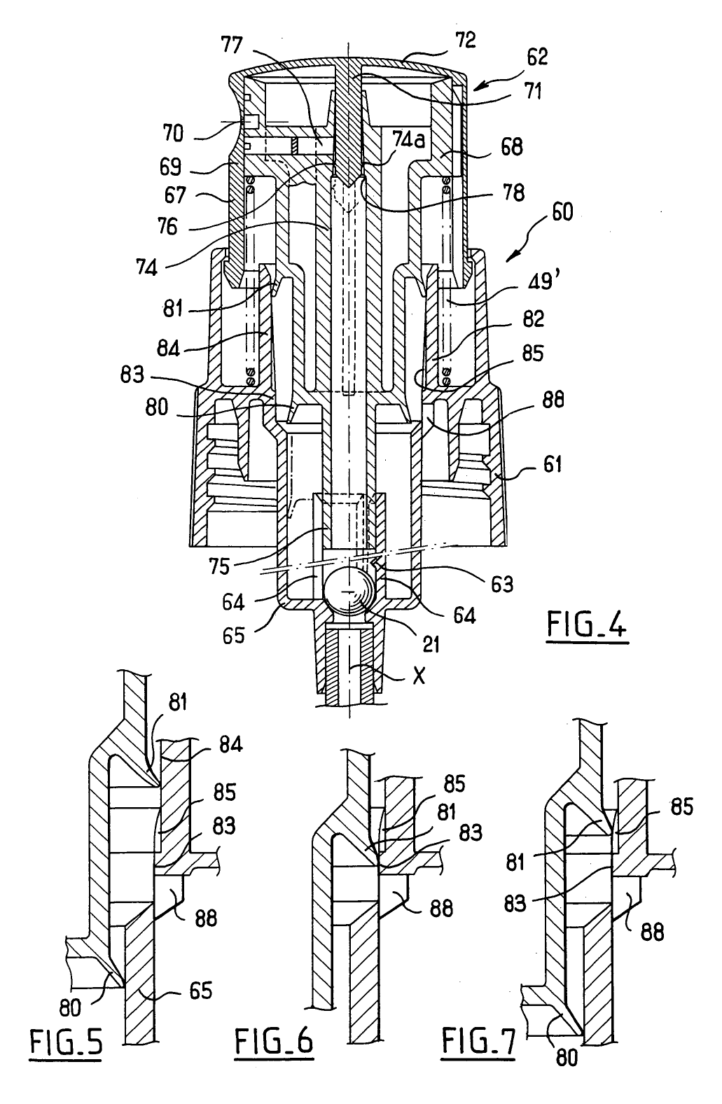

FIG. 4 is a diagrammatic and fragmentary view in axial section of a pump constituting another embodiment of the invention;

FIGS. 5 to 7 are diagrammatic and fragmentary views showing three stages in the operation of the FIG. 4 pump;

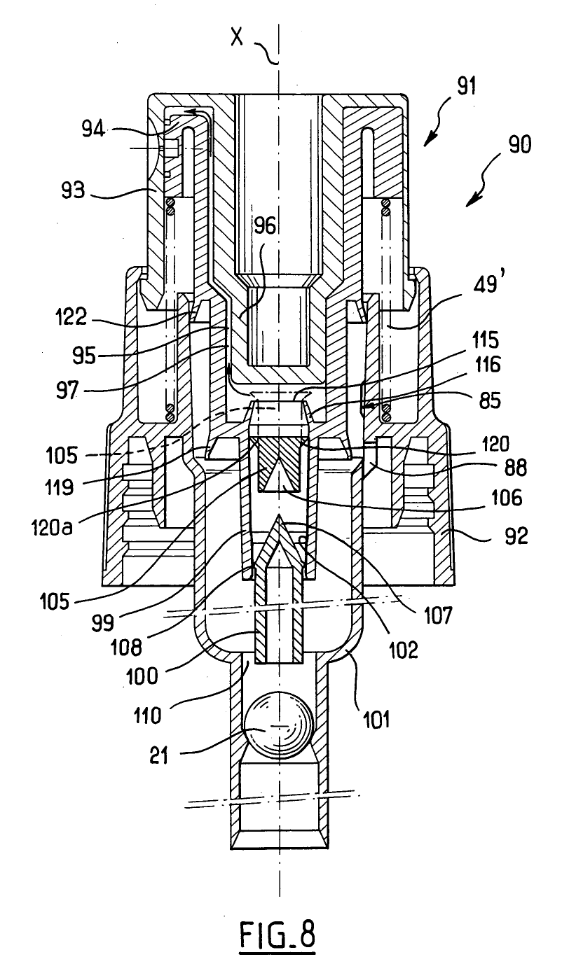

FIG. 8 is a diagrammatic and fragmentary view of another embodiment of the invention; and

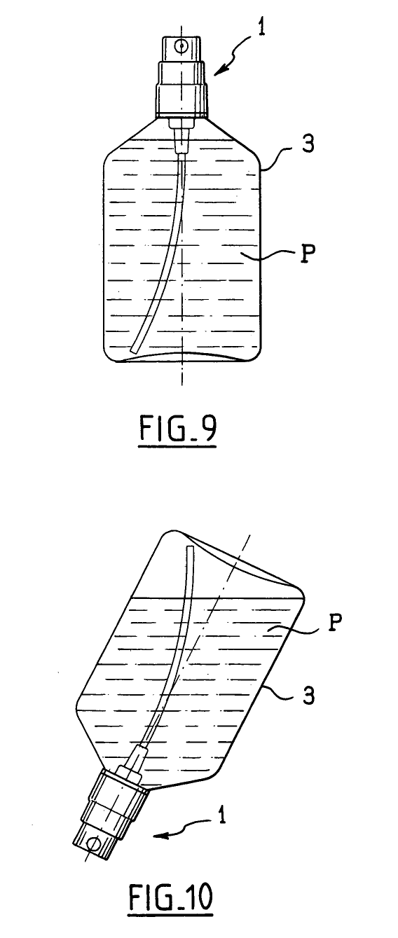

FIGS. 9 and 10 are diagrammatic and fragmentary views of a receptacle fitted with the pump of FIG. 1, shown respectively head-up and head-down.

FIGS. 1 to 9 show a pump 1 mounted on a neck 2 of axis X of a receptacle 3 containing a substance P to be dispensed.

The pump 1 comprises a stationary portion 4 and a moving assembly 5 capable of moving along the axis X.

The stationary portion 4 includes an assembly skirt 9 secured to the neck 2 of the receptacle 3. In the example described, the assembly skirt 9 is snap-fastened to the neck 2, but in a variant it could be fastened some other way, for example by screw fastening or by crimping.

The assembly skirt 9 is extended upwards by a cylindrical wall 10 having an inwardly-directed annular bead 11 at its top end.

The stationary portion 4 also includes a sealing lip 12 bearing against the inside surface of the neck 2, and a pump body 14 co-operating with the moving assembly 5 to define a variable volume pump chamber 6. When the pump 1 is observed head-up, as shown in FIG. 9, the pump body 14 presents an upper tubular wall 15 and a lower tubular wall 16 that are coaxial about the axis X.

The lower wall 16 presents a circularly cylindrical inside surface 16a of diameter smaller than the diameter of the likewise circularly cylindrical inside surface 15a defined by an annular bead 17 present at the top end of the upper wall 15.

The upper wall 15 is provided at its base with a plurality of side openings 18, only one of which is visible in the drawing, these openings 18 being distributed circumferentially around the upper wall 15. The pump body 14 need have only one of said openings.

The lower wall 16 is connected to an endpiece for fastening a dip tube 24 to the bottom end of the pump body 14, said endpiece 20 also defining a housing for a ball 21, which ball is held in its housing by bosses 22.

The housing for the ball 21 communicates via an orifice 23 with the dip tube 24.

The moving assembly 5 comprises a pushbutton 30 having an insert 31 fitted therein.

The pushbutton 30 comprises a first portion 32 which is stationary relative to the insert 31, the first portion 32 including an outer tubular skirt presenting an annular bead 33 at its bottom end suitable for co-operating with the annular bead 11 of the cylindrical wall 10 in order to retain the moving assembly 5 on the portion 4 of the pump that is fastened to the receptacle 3.

The first portion 32 also includes a delivery orifice 34 communicating with a swirling channel chamber 35 formed in the insert 31 so as to enable the substance to be dispensed in the form of a spray.

The pushbutton 30 also includes a second portion 36 that is movable relative to the first portion 32, and in the example described it comprises a hollow rod that is open at its top end and closed at its bottom end. This rod is connected to the first portion 32 by a web of material 37 that is elastically deformable and annular in shape.

The insert 31 has a central duct 39 in which the second portion 36 of the pushbutton 30 is engaged while leaving a passage 38 for delivery of the substance when the pump is actuated to dispense the substance.

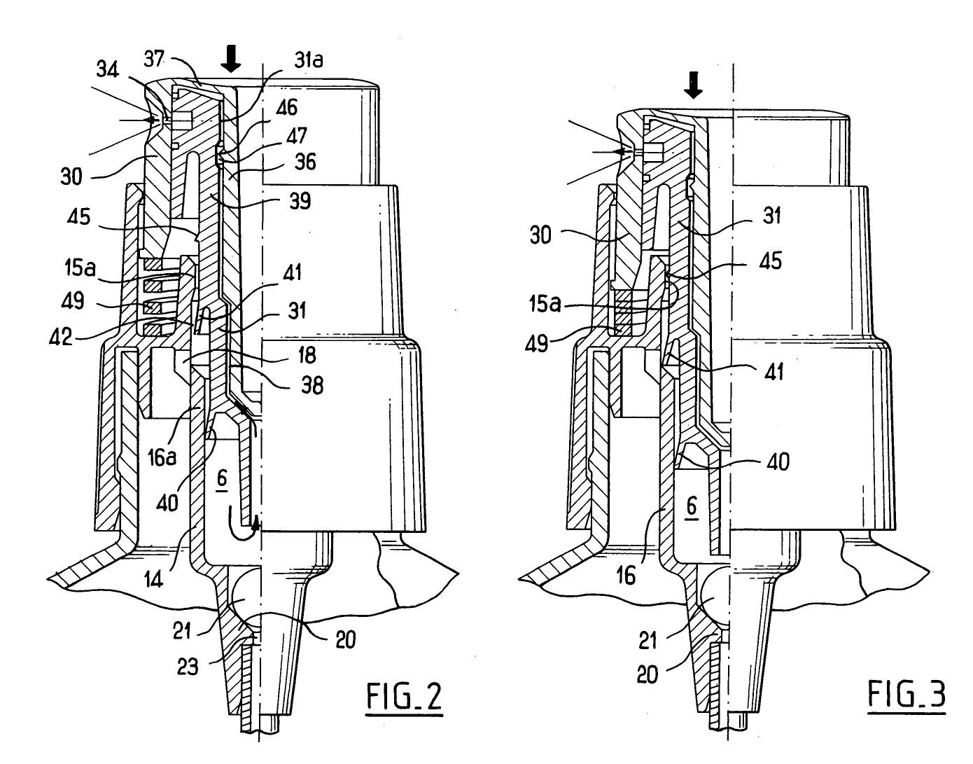

The insert 31 includes a first annular lip 40 arranged to press in leaktight manner against the inside surface 16a of the pump body 14 while the moving assembly 5 is being moved downwards through a determined stroke from its rest position of FIG. 1, as can be seen in FIG. 2.

Above the first lip 40, the insert 31 has a second annular lip 41 bearing in leaktight manner against the inside surface 15a while the moving assembly is in its rest position, as shown in FIG. 1.

The shape of this second lip 41 is selected in such a manner that when it leaves the annular bead 17 during displacement of the moving assembly 5 to reduce the volume of the pump chamber 6, the lip 41 ceases to bear in leaktight manner against the upper wall 15 and co-operates therewith to leave an air intake passage 42 enabling the inside of the receptacle 3 to communicate with the outside through the openings 18, as shown in FIG. 2.

In the example described, each of the lips 40 and 41 is frustoconical in shape, flaring towards the pump chamber 6.

A third annular lip 45 is made on the insert 31 above the second lip 41 so as to bear in leaktight manner against the inside surface 15a when the moving assembly 5 is in its end-of-dispensing-stroke position, as shown in FIG. 3, so as to close the air intake passage 42.

The second portion 36 of the pushbutton 30 includes an annular lip 46 suitable for bearing in leaktight manner against the insert 31 to close the passage 38 for delivering substance while the moving assembly 5 is in its rest position.

A setback such as an annular groove is made in the insert 31, and the lip 46 occupies a position facing this setback while the second portion 36 is moving downwards through a certain distance relative to the insert 31, as shown in FIG. 2, thus allowing substance to pass from the pump chamber towards the outlet orifice 34.

The pushbutton 30 includes a helical spring 49 working in compression, and made in the example described integrally with the first portion 32, extending it downwards. The spring 49 is housed between the outer wall 10 and the inner wall 15 of the stationary portion 4.

The pump 1 operates as follows.

It is assumed that the pump 1 is being used head-up, and that it is initially in its rest position as shown in FIG. 1. It is assumed that the pump chamber 6 is full of substance, following an earlier actuation cycle of the pump.

The inside of the receptacle is isolated from the outside by leaktight contact between the second lip 41 and the inside surface 15a, and by leaktight contact of the lip 46 of the pushbutton on the surface 31a of the insert 31 situated above the setback 47.

In order to dispense the substance, the user exerts downward pressure on the central, second portion 36 of the pushbutton 30.

Given that the rest shape of the web of material 37 is slightly outwardly convex, a certain amount of force is required to cause this web of material 37 to change configuration and deform, taking up a substantially upwardly concave configuration, as shown in FIG. 2.

In this way, the moving assembly 5 begins by moving relative to the stationary portion 4 of the pump without the displacement of the second portion 36 relative to the first portion 32 being sufficient for the lip 46 to cease bearing in leaktight manner against the surface 31a of the insert 31.

In particular, in the example described, the passage 38 for delivering substance remains closed by the lip 46 at least until the first lip 40 comes to bear in leaktight manner against the surface 16a of the pump body 14.

The pressure of the substance contained in the pump chamber 6 increases as the moving assembly continues to move, the ball 21 being pressed against its seat.

The force needed to move the moving assembly 5 relative to the stationary portion 4 increases as the substance is compressed in the pump chamber 6, and at some moment the force exerted on the pushbutton 30 becomes sufficient for the web of material 37 to deform to such an extent as to allow the lip 46 to reach the setback 47.

When a flow of substance can be established via the passage 38 between the pump chamber 6 and the outlet orifice 34, the substance is already compressed in the pump chamber 6, so the chamber 35 is fed with sufficient pressure to form a spray. The pump is said to be a “precompression” pump.

Continued displacement of the moving assembly 5 relative to the stationary portion 4 of the pump causes the volume of the pump chamber to be decreased.

During downward displacement of the moving assembly 5, the second lip 41 ceases to press in leaktight manner against the surface 15a, such that the inside of the receptacle can communicate with the outside through the openings 18 and the passage 42, so as to allow air to be taken in, where appropriate.

At the end of the depression stroke of the moving assembly 5 relative to the stationary portion 4, the third lip 45 comes to bear against the surface 15a, thereby closing communication between the inside of the receptacle and the outside via the passage 42. During the displacement of the moving assembly 5, the helical spring 49 is compressed.

When the user ceases to press on the pushbutton 30, the web of material 37 tends to return to its initial configuration and the second portion 36 tends to move upwards relative to the first portion 32, thereby reestablishing leaktight contact between the lip 46 and the insert 31, and closing the passage 38 that put the inside of the pump chamber 6 into communication with the delivery orifice 34.

Continued upward movement of the moving assembly 5 relative to the stationary portion 4 is accompanied by substance being sucked into the pump chamber 6 under the effect of the suction that is created therein, the first lip 40 spring on the surface 16a. Air intake can occur via the passage 42 in order to compensate inside the receptacle for the volume of substance drawn in by the pump. While air is being taken in, the air that is sucked into the receptacle can oppose delivery of the substance via the passage 42 given the narrowness of the passage. Once the pump returns to its rest position, the substance can remain inside the pump chamber 6 because the ball 21 tends under the effect of its own weight to be pressed against its seat and to close the orifice 23.

When the pump is used head-down, the pump chamber 6 can fill by the openings 18. Substance is dispensed in the same manner as in the head-up position. The same applies when the pump is used in an intermediate position between its head-up and head-down positions, with the delivery orifice 34 pointing downwards, providing the receptacle contains sufficient substance.

When the pump is used head-down, the fact that firstly the second lip 41 presses in leaktight manner against the surface 15a while the pump is at rest and secondly that the lip 46 presses against the insert 31 in leaktight manner enables any risk of substance leakage to be avoided.

This risk of substance leakage is also prevented or reduced if the pump is held head-down with the moving assembly 5 in its end-of-stroke position, because of the third lip 45 pressing against the surface 15a.

In the example considered, the pump chamber 6 presents a volume that is greater than the quantity or “dose” of substance that is dispensed, thereby making it possible to reduce the risk of the pump ceasing to be primed.

FIGS. 4 to 7 show a pump 60 comprising a stationary portion 61 and a moving assembly 62 capable of moving along the axis X.

The stationary portion 61 is similar to the above-described stationary portion 4 with the exception that in this example the ball 21 is retained in its housing by bosses 63 made on tabs 64 extending from the bottom of the pump body 65, and the openings 18 are replaced by a single opening 88 situated on the side opposite from the delivery orifice 70.

The moving assembly 62 comprises a pushbutton 67 having an insert 68 fitted thereto.

The pushbutton 67 comprises a first portion 69 which is stationary relative to the insert 68 and which includes the delivery orifice 70, which orifice is similar to the above-described delivery orifice 34.

The pushbutton 67 further comprises a spike 71 which is movable axially relative to the first portion 69 and which is connected thereto by a web of material 72, like the second portion 36 of the pump 1.

The insert 68 includes a central duct 74 whose bottom end 75 penetrates into the space defined between the tabs 64.

The spike 71 is engaged in the top portion of the duct 74 and includes an annular bead 76 bearing in leaktight manner in the rest position against an annular region 74a of the wall of the duct 74, as shown in FIG. 4, thereby interrupting communication between the substance delivery passage 77 and the pump chamber.

The central duct 74 includes a portion of enlarged section 78 beneath the region 74a, which portion is arranged so that when the spike 71 is pushed into the duct 74 over a certain stroke, the annular bead 76 ceases to bear against the region 74a, thereby enabling substance to be delivered via the passage 77.

In the example described, the fact that the opening 88 is situated on the side opposite to the delivery orifice 70, avoids the pump chamber emptying in the event of the pump being used substantially horizontally with the delivery orifice 70 pointing downwards.

Unlike the insert 31 of the above example, the insert 68 has only two annular lips 80 and 81, analogous respectively to the annular lips 40 and 41. In other words, the insert 68 does not have a third annular lip.

The upper wall 82 of the pump body 65 comprises two annular regions 83 and 84 that are circularly symmetrical and that have at least one channel 85 extending along the axis X formed between them.

The second annular lip 81 can be pressed in leaktight manner against these regions 84 and 83, respectively when the moving assembly 62 is occupying its rest position and its end-of-stroke position, as shown in FIGS. 5 and 6, and the channel 85 can allow air to be taken in when the moving assembly 62 is occupying an intermediate position, as shown in FIG. 7.

Like the pump 1, the pump 60 is a precompression pump.

In order to dispense substance, the user exerts downward pressure on the top of the pushbutton 67.

The moving assembly 62 begins by moving relative to the stationary portion 61 without the spike 71 moving relative to the first portion 69 sufficiently for the annular bead 76 to cease pressing in leaktight manner against the region 74a of the duct 74.

The passage 77 for delivering the substance thus remains isolated from the pump chamber by the bead 76, at least until the first lip 84 comes to bear in leaktight manner against the pump body 65, as shown in FIG. 5.

As described with reference to the pump 1, at a certain moment, the force exerted on the pushbutton 67 becomes sufficient for the web of material 72 to deform to a certain extent as to allow the annular bead 76 to go past the enlarged section 78, thereby allowing the substance to reach the passage 77.

During downward displacement of the moving assembly 62, as shown in FIG. 7, the second annular lip 81 ceases to press against the pump body 65, thereby making it possible for air to be taken in via the channel 85, should that be necessary.

At the end of the stroke of the moving assembly 62, the second annular lip 81 comes to press in leaktight manner against the region 83, as shown in FIG. 6, thereby preventing communication between the inside of the receptacle and the outside.

When the user ceases to press on the pushbutton 67, the web of material 72 tends to return to its initial configuration under the action of the spring 49′, and the spike 71 moves upwards relative to the first portion 69 of the pushbutton 67 in such a manner that the annular bead 76 again presses against the region 74a of the duct 74. The passage 77 for delivering the substance is thus closed.

Continued upward movement of the moving assembly 62 relative to the stationary portion 61 causes substance to be sucked into the pump chamber, the first lip 80 pressing against the pump body 65 underneath the opening 88, as shown in FIG. 5.

Air may be taken in through the opening 88 while the second lip 81 is in an intermediate position between the regions 83 and 84, as shown in FIG. 7.

When the pump 60 is used head-down, the pump chamber can fill via the opening 88.

It is not essential in the invention for the pushbutton to have first and second portions that are movable relative to each other as is the case in the example described above.

FIG. 8 shows a pump 90 comprising a moving assembly 91 capable of moving relative to a stationary portion 92.

The moving assembly 91 comprises a pushbutton 93 having an insert 94 fitted therein. The insert has two annular lips 119 and 122 similar respectively to the above-described lips 80 and 81.

The pushbutton 93 is entirely stationary relative to the insert 94.

The insert 94 has a recess 95 extending substantially along the axis X and co-operating with a tubular central portion 96 of the pushbutton 93 to define a portion of the passage 97 for delivering the substance.

At its first portion, the insert 94 presents a cylindrical skirt 99 that is circularly symmetrical about the axis X and that is suitable for engaging on a central spike 100 of the pump body 101.

At its bottom end, the inside of the skirt 99 presents an annular bead 102, and at its top end it presents an opening 115 defined by a downwardly flaring frustoconical portion 116.

Prior to first use of the pump, the skirt 99 houses a valve member 105 disposed above the annular bead 102 and including at its top end a head 120 which can initially be secured to the skirt 99, the head 120 having a frustoconical annular surface 120a.

The skirt 99 and the valve member 105 may be made as a single piece by molding, and the valve member 105 may be connected to the skirt 99 by a web of frangible material making it possible, after rupturing, to allow the valve member 105 to move relative to the skirt 99. The valve member 105 may also be constituted by an element made separately and then installed in the skirt 99 after the skirt has been manufactured.

The valve member 105 has a bottom conical recess 106 suitable for engaging on the conically-shaped top end 107 of the spike 100 when the moving assembly 91 has been depressed over a certain stroke.

At the base of the conical portion 107, the spike 100 has an annular bead 108, and when the moving assembly 91 is in its rest position, the bead 108 bears against the annular bead 102 of the skirt 92 so as prevent substance from penetrating into the skirt 99.

The spike 100 is connected to the remainder of the pump body 101 by bridges of material 110, e.g. being integrally molded with the remainder of the pump body.

Prior to first use of the pump 90, the user pushes in the moving assembly 91, and after it has moved through a certain stroke relative to the stationary portion 92, the valve member 105 comes into abutment against the conical portion 107 of the spike 100. As the user continues to exert force on the moving assembly 91, the valve member 105 goes through the frustoconical portion 116 of the skirt 99 to take up the position shown in chain-dotted lines in FIG. 8, in which position the valve member 105 co-operates with the opening 115 to form a check valve.

The pump 90 then operates as follows.

It is assumed that the pump 90 is being used headup, and is initially in its rest position as shown in FIG. 8.

It is assumed that the pump chamber is full of substance following an earlier actuation cycle of the pump.

The pump chamber is isolated from the outside by leaktight contact of the second lip 122 on the pump body 101 and by leaktight contact also of the annular bead 108 of the spike 100 on the annular bead 102 of the skirt 99.

To dispense the substance, the user exerts downward pressure on the moving assembly 91.

The pump 90 may be a precompression pump like the pumps 1 and 60, providing the height of the annular bead 102 is selected so that the beads 102 and 108 press against each other over a certain stroke of the moving assembly 91 relative to the stationary portion 92, at least until the annular lip 119 comes, to press against the pump body 101 beneath the opening 88.

After a certain stroke has been travelled, the annular beads 102 and 108 cease to press against each other, thereby enabling the substance contained in the pump chamber to flow in the skirt 99 towards the delivery passage 97, with the pressure of the substance being suitable for lifting the valve member 105 so that the surface 120a of the head 120 ceases to press against the edge of the opening 115.

While the moving assembly 91 is moving inwards relative to the stationary portion 92, the first and second annular lips 119 and 122 co-operate with the pump body 101 in a manner analogous to that described above for the annular lips 80 and 81.

When the user ceases the press on the pushbutton 93, the moving assembly 91 tends to return to its initial position under drive from the spring 49′.

The head 120 of the valve member 105 then returns to press against the edge of the opening 115 of the skirt 99 so as to isolate the pump chamber from the outside and so as to enable substance to be sucked into pump chamber under the effect of the suction which is created therein, the first lip 119 being pressed against the pump body 101 beneath the opening 88.

The invention is naturally not limited to the embodiments described above.

The ball 21 may be replaced in particular by any other suitable check valve, in particular an elastomer check valve fitted to or overmolded on the pump body,

It would not go beyond the ambit of the present invention for the pump to operate without precompression, using a moving assembly configured differently.

Throughout the description, including in the claims, the term “comprising a” should be considered as synonymous with “comprising at least one” unless specified to the contrary.

What is claimed is:

1. A pump (1; 60; 90) for mounting on a receptacle (3), the pump comprising:
a pump body (14; 65; 101);
a moving assembly (5; 62; 91) that is movable relative to the pump body and that co-operates therewith to define a pump chamber of variable volume, the pump chamber being suitable for communicating with the inside of the receptacle via at least one opening (18; 88) of the pump body disposed in such a manner as to enable the pump to operate in a head-down position;
wherein the pump comprises:
an air intake passage (42; 85) formed between the pump body and the moving assembly and capable of communicating with the opening (18; 88) of the pump body;
a first lip (40; 80; 119) arranged, after the moving assembly has moved away from a rest position in the substance-dispensing direction, to press in leaktight manner against the pump body and prevent communication between the inside of the receptacle and the pump chamber (6) via the opening (18; 88); and
a second lip (41; 81; 122) situated above the first lip when the pump is observed in the head-up position, said second lip (41; 81; 122) being arranged to close the air intake passage (42; 85) when the moving assembly is in its rest position and to release said passage when the moving assembly (5; 62, 91) is displaced in the substance-dispensing direction.

2. A pump according to the preceding claim, wherein each of the first (40; 80; 119) and second (41; 81; 122) lips is substantially frustoconical in shape, flaring towards the pump chamber (6).

3. A pump according to the preceding claims, wherein the moving assembly includes a third lip (45) disposed so as to press against the pump body to close the air intake passage (42) when the moving assembly is at the end of its substance-dispensing stroke.

4. A pump according to one of claims 1 and 2, wherein the pump body and the second lip (81; 122) are arranged in such a manner as to close the air intake passage (42; 85) when the moving assembly is at the end of its substance-dispensing stroke.

5. A pump according to the preceding claim, wherein the pump body includes a setback (85) situated between two regions (83, 84) against which the second lip (81; 122) presses while the moving assembly occupies respectively a rest position and an end-of-stroke position, said setback providing communication between said regions while the moving assembly is occupying an intermediate position between its rest and end-of-stroke positions.

6. A pump according to any one of the preceding claims, wherein the moving assembly comprises a pushbutton (30; 67; 93) and an insert (31; 68; 94) fitted thereto, the pushbutton and the insert being arranged together to define a passage (38; 97) for delivering the substance, at least while the pump is actuated to dispense the substance.

7. A pump according to the preceding claim and to claim 3, wherein the first (40; 80; 119), second (41; 81; 122), and third (45) lips are made on the insert (31; 68; 94).

8. A pump according to one of claims 6 to 7, wherein the pushbutton comprises two portions (32, 36; 69, 71), one (32; 69) of which is stationary relative to the insert (31), and the other one (36) of which is movable relative thereto.

9. A pump according to the preceding claim, wherein the movable portion (36; 71) of the pushbutton and the insert (31; 68) include respective surfaces suitable for co-operating to close the passage for delivering the substance while the moving assembly is in its rest position and for opening said passage once the movable portion (36; 71) has moved through a determined distance relative to the stationary portion (32; 69).

10. A pump according to the preceding claim, wherein the pushbutton (30; 67) is arranged so that the movable portion (36; 71) can move relative to the insert (31; 68) through said determined distance from its rest position only once the force exerted on the pushbutton exceeds a threshold.

11. A pump according to any one of claim 8 to 10, wherein the stationary portion (32; 69) and the movable portion (36; 71) of the pushbutton (30; 67) are interconnected by a web (37; 72) of elastically-deformable material.

12. A pump according to the preceding claim, wherein the web of material is annular in shape.

13. A pump according to any one of the preceding claims, including a resilient return element (49; 49′) suitable for returning the moving assembly into its rest position.

14. A pump according to the preceding claim, wherein the resilient return element is disposed outside the pump chamber.

15. A pump according to one of claims 12 to 13, wherein the resilient return element comprises a helical spring working in compression.

16. A pump according to any one of claims 13 to 15, wherein the resilient return element is made integrally with the pushbutton (30).

17. A pump according to any one of the preceding claims, wherein the pump body (14; 65; 101) is arranged to enable a dip tube (24) to be fastened.

18. A pump according to the preceding claim, including a check valve (20, 21) that closes while the volume of the pump chamber (6) is decreasing and that opens while the volume of the pump chamber is increasing, said check valve being disposed in such a manner as to enable the pump chamber to be fed with substance by means of the dip tube (24).

19. A pump according to any one of the preceding claims, in which the moving assembly includes a delivery orifice (70), wherein the delivery orifice (70) is situated on the side opposite from the opening (88) about the axis (X) of the pump.

20. A pump according to any one of the preceding claims, wherein the volume of the pump chamber (6) in the rest position is greater than the volume of a quantity or “dose” of substance to be dispensed.

21. A pump according to one of claims 6 and 7 and one of claims 13 to 20, wherein the pushbutton (93) is entirely stationary relative to the insert (94).

22. A pump according to the preceding claim, wherein the insert (94) includes a skirt (99) suitable for co-operating in leaktight manner with a spike (100) of the pump body (101) when the pump is at rest, in such a manner as to isolate the pump chamber from the outside.

23. A pump according to one of claims 21 to 22, wherein the insert (94) includes a valve member (105) suitable for closing a top opening (115) of the skirt (99) while the volume of the pump chamber is increasing and for enabling substance to flow therethrough while the volume of the pump chamber is decreasing.

24. A pump according to the preceding claim, wherein, before first use of the pump (90), the valve member (105) is housed entirely inside the skirt (99).

25. A pump according to the preceding claim, wherein the valve member (105) includes a conical recess (106) suitable for co-operating with a conical portion (107) of the spike (100).

26. A receptacle fitted with a pump according to any one of the preceding claims.
